(19) United States
(12) Patent Application Publication
(10) Pub. No.: US 2026/0217215 A1
(43) Pub. Date: Jul. 30, 2026

(54) VEHICLE CONTROL DEVICE AND INFORMATION PROCESSING SYSTEM

(71) Applicant: TOYOTA JIDOSHA KABUSHIKI KAISHA, Toyota-shi (JP)

(72) Inventors: Ryosuke TANIMURA, Nagoya-shi (JP); Aika MIYAJIMA, Nagoya-shi (JP); Akari YAMADA, Nagoya-shi (JP); Reina YAMAMURA, Nagoya-shi (JP)

(73) Assignee: TOYOTA JIDOSHA KABUSHIKI KAISHA, Toyota-shi (JP)

(21) Appl. No.: 19/335,433

(22) Filed: Sep. 22, 2025

(30) Foreign Application Priority Data
Jan. 28, 2025 (JP) 2025-012443

(51) Int. Cl. B60R 25/04; B60R 25/24; G07C 9/00

(52) U.S. Cl. CPC B60R 25/04; B60R 25/245; G07C 9/00309; B60R 2025/0415; B60R 2325/101; G07C 2009/00793; G07C 2209/63

(57) ABSTRACT

The present disclosure relates to a vehicle control device and an information processing system. The vehicle control device includes a processor, in which the processor is configured to lock an engine start of a vehicle or release a lock of the engine start of the vehicle according to a connection status of a communication unit.

### CROSS-REFERENCE TO RELATED APPLICATION

This application claims priority to Japanese Patent Application No. 2025-012443 filed on January 28, 2025. The disclosure of the above-identified application, including the specification, drawings, and claims, is incorporated by reference herein in its entirety.

### BACKGROUND

### Technical Field

The present disclosure relates to a vehicle control device and an information processing system.

### Description of Related Art

Japanese Unexamined Patent Application Publication No. 2014-146120 (JP 2014-146120 A) discloses a technique for locking an engine of a vehicle such that the engine cannot be started when a transmission and reception antenna or a global positioning system (GPS) antenna of the vehicle is removed.

### SUMMARY

In the related art, since it is extremely difficult to recover a target vehicle after a malicious act, such as dismantling of the target vehicle or taking of the target vehicle to another country, by a malicious person is performed, there is a demand for detecting the malicious act as early as possible.

However, in JP 2014-146120 A, the engine is merely locked such that the engine cannot be started when the antenna is removed, and thus there is room for further improvement.

The present disclosure has been made in view of the above, and an object of the present disclosure is to provide a vehicle control device and an information processing system capable of suppressing a malicious act on a target vehicle in advance.

A vehicle control device according to the present disclosure includes a communication unit configured to communicate with an outside; and a processor, in which the processor includes locking an engine start of a target vehicle when the processor receives, from the outside, an instruction to cut off a connection of the communication unit.

In addition, a vehicle control device according to the present disclosure includes

a communication unit configured to communicate with an outside; and a processor, in which the processor is configured to lock an engine start of a target vehicle or release a lock of the engine start of the target vehicle in accordance with a connection status of the communication unit.

In addition, an information processing system according to the present disclosure includes

multiple vehicles each including a first communication unit configured to communicate with an outside and a first processor configured to lock an engine start or release a lock of the engine start; and

an information processing device including a second communication unit configured to communicate with the vehicles and a second processor,

in which the second processor is configured to.

acquire position information of each of the vehicles at a predetermined interval,

cluster, when there is a missing vehicle with a communication interruption and unknown whereabouts among the vehicles,

latest position information of the missing vehicle before the communication interruption within a predetermined range, and store the clustered latest position information in a memory, specify a range that includes a position corresponding to the position information equal to or greater than a predetermined threshold value, from the range in which clustering is performed, and

specify a target vehicle heading toward the specified range based on the position information of each of the vehicles.

According to the present disclosure, an effect of suppressing a malicious act on a target vehicle in advance can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of an information processing system according to Embodiment 1 of the present disclosure;

FIG. 2 is a sequence diagram showing an example of information exchanges among a receivable collection server, a receivables management server, a vehicle information server, and a vehicle according to Embodiment 1 of the present disclosure; and

FIG. 3 is a flowchart showing an outline of processing executed by the receivable collection server according to Embodiment 1 of the present disclosure.

### DETAILED DESCRIPTION OF EMBODIMENTS

Hereinafter, a vehicle control device and an information processing system according to the embodiment of the present disclosure will be described with reference to the drawings. The components in the following embodiments include elements that can be easily replaced by those skilled in the art or substantially the same components.

### Vehicle Control System

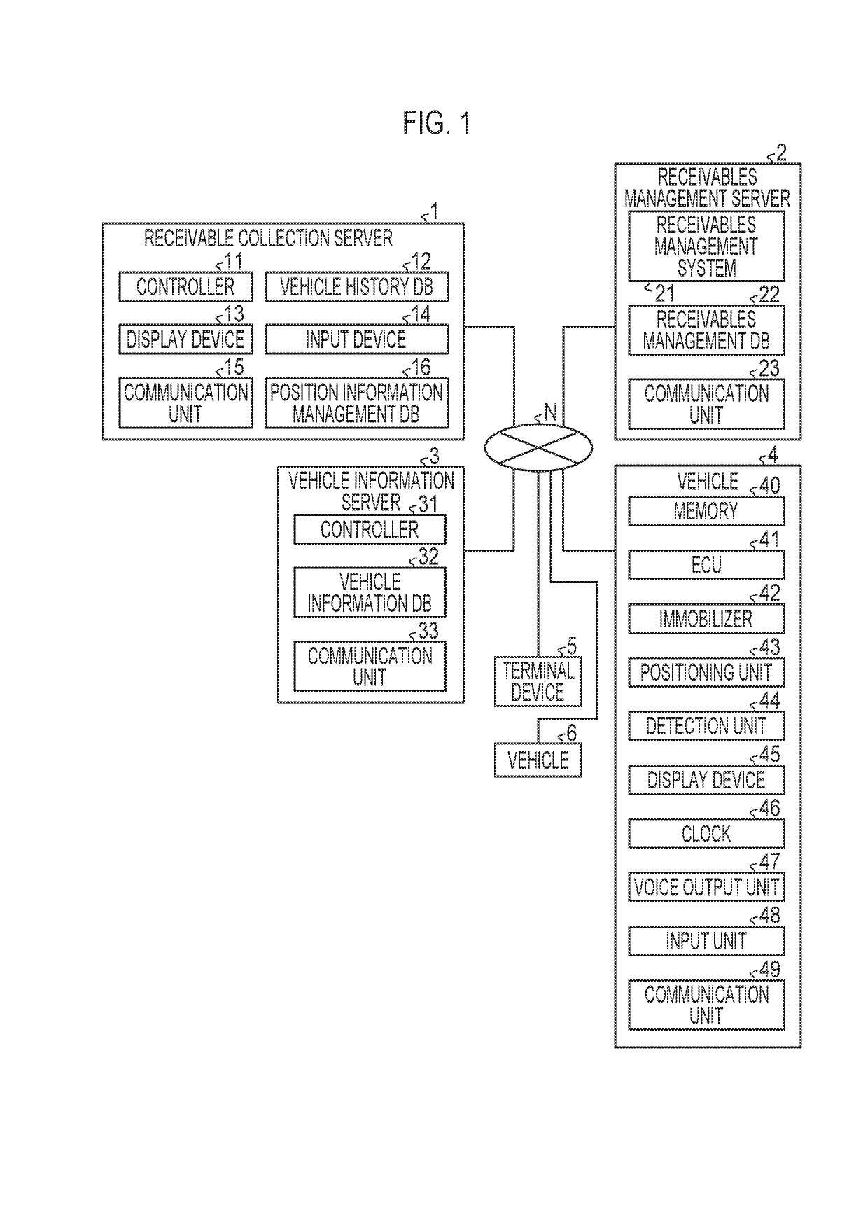

FIG. 1 is a block diagram showing a schematic configuration of an information processing system according to an embodiment of the present disclosure. The information processing system 100 shown in FIG. 1 includes a receivable collection server 1, a receivables management server 2, a vehicle information server 3, a vehicle 4, a terminal device 5, and a vehicle 6. The receivable collection server 1, the receivables management server 2, the vehicle information server 3, the vehicle 4, the terminal device 5, and the vehicle 6 all have a communication function, and are configured to communicate with each other via the network N and exchange various information. The network N is constituted by a public line network, such as an Internet line network or a mobile phone line network. In addition, the receivable collection server 1 in the information processing system according to the embodiment functions as an information processing device that performs remote control of operations of the vehicle 4 and the vehicle 6 (particularly, the engine start lock and the release of the engine start lock by the immobilizer).

In addition, in the embodiment, examples of the "receivables" include receivables related to an installment contract at the time of vehicle purchase, and receivables related to a lease contract of the vehicle 4 and the vehicle 6. Examples of the "receivables" further include receivables related to a subscription contract of the vehicle 4 and the vehicle 6, and receivables related to a car rental contract of the vehicle 4 and the vehicle 6.

In addition, the creditor in the embodiment is, for example, a holder (owner) of the vehicle 4 or the vehicle 6. Specifically, examples of the creditor include a dealer, a credit company, and a bank that sells the vehicle 4 and the vehicle 6. In addition, the debtor in Embodiment 1 is, for example, a user of the vehicle 4. Specifically, examples of the debtor include a purchaser of the vehicle 4, a contractor such as a lease contract, and a company. In addition, in FIG. 1, two vehicles, the vehicle 4 and the vehicle 6, are described as an example, but the present disclosure is not limited thereto. It is assumed that a plurality of vehicles owned by the creditor is present, but for the sake of simplifying the description, a case of two vehicles, a vehicle 4 and a vehicle 6, will be described below. Further, in the following, any vehicle including the vehicle 4 and the vehicle 6 will be referred to as a plurality of vehicles.

### Function Configuration of Receivable Collection Server

First, a function configuration of the receivable collection server 1 will be described. The receivable collection server 1 remotely controls the operation of the vehicle 4 to collect the receivables related to the vehicle 4. As shown in FIG. 1, the receivable collection server 1 includes a controller 11, a vehicle history database (DB) 12, a display device 13, an input device 14, a communication unit 15, and a position information management DB 16.

The controller 11 is realized by a processor, such as a central processing unit (CPU), and a memory (main storage unit), such as a random access memory (RAM) or a read only memory (ROM). The controller 11 acquires predetermined information from the vehicle history DB 12 and the vehicle information server 3 when the vehicle 4 satisfies a requirement of the engine start lock that is predetermined (hereinafter, referred to as "engine start lock requirement"). Then, the controller 11 determines whether to activate the engine start lock based on the information. When the controller 11 is determined to activate the engine start lock, the controller 11 locks the engine start of the vehicle 4 (controls the engine such that the engine does not start).

Examples of the "engine start lock requirement" include a case where the debtor of the vehicle 4 is in default (for example, payment delay). The determination of whether the engine start lock requirement is satisfied is made by, for example, the receivable collection server 1. Then, when there is the vehicle 4 (target vehicle) that satisfies the engine start lock requirement, the information for specifying the vehicle 4 (for example, a vehicle identification number (VIN number)) is transmitted from the receivables management server 2 to the receivable collection server 1. The target vehicle refers to, for example, the vehicle 4 or the vehicle 6 that is the subject to the receivable.

In addition, the controller 11 acquires the position information of each of the vehicles at a predetermined interval. When an unknown vehicle with a communication interruption and unknown whereabouts occurs among the vehicles, the controller 11 clusters the latest position information of the unknown vehicle before the communication interruption occurs within a predetermined range and stores the latest position information in the position information management DB 16. Then, the controller 11 specifies a range that contains a position corresponding to position information equal to or greater than a threshold value that is predetermined, from the range in which clustering is performed. Thereafter, the controller 11 specifies the target vehicle heading toward the specified range that contains the position corresponding to the position information equal to or greater than the threshold value that is predetermined, based on the position information of each of the vehicles, from the range in which clustering is performed. Finally, the controller 11 transmits a lock signal for locking the engine start of the target vehicle by remote control to the target vehicle via the communication unit 15 to lock the engine start of the target vehicle by remote control. Further, when the controller 11 receives the first signal indicating that the payment of the debt for the vehicle 4 or the vehicle 6 (target vehicle) is not correctly performed from the receivables management server 2, the controller 11 transmits the first signal to the vehicle 4 or the vehicle 6 via the vehicle information server 3. Further, the controller 11 restricts a part of the functions of the vehicle 4 by the remote control. Specifically, the controller 11 locks the engine start of the vehicle 4 by the remote control. In the embodiment, the controller 11 functions as a second processor.

The vehicle history DB 12 is constituted using a hard disk drive (HDD), a solid state drive (SSD), or the like, and is a database that stores various information related to the vehicle 4. The vehicle history DB 12 acquires, for example, the position information from the vehicle information server 3 and stores the position information in association with a vehicle identification number (VIN number) or the like.

The display device 13 is realized by, for example, a liquid crystal display (LCD) or an organic EL display (OLED). The display device 13 displays various information under the control of the controller 11.

The input device 14 is realized by, for example, a touch panel, a keyboard, or a pointing device. The input device 14 receives an input of various operations by the user and outputs a signal according to the received operation to the controller 11.

The communication unit 15 is constituted of a local area network (LAN) interface board, a wireless communication circuit for wireless communication, or the like. The communication unit 15 exchanges information between the receivables management server 2 and the vehicle information server 3 by communication via the network N under the control of the controller 11. In the embodiment, the communication unit 15 functions as a second communication unit.

The position information management DB 16 is constituted using a hard disk drive (HDD), a solid state drive (SSD), or the like. The position information management DB 16 acquires the position information of each of the vehicles at a predetermined time interval via the communication unit 15 under the control of the controller 11, and stores the acquired position information and the vehicle identification number (VIN number) of the vehicle or the like in association with each other. Here, the vehicles are, for example, the vehicle 4 and the vehicle 6. In addition, the predetermined time interval is, for example, 10 minutes. The vehicle history DB 12 stores a steady stop position information that is, for example, information on a position where the vehicle 4 is steadily or regularly stopped or parked, that is created based on the position information stored in the vehicle history DB 12 by the controller 11.

### Function Configuration of Receivables Management Server

Next, a function configuration of the receivables management server 2 will be described. The receivables management server 2 is for managing the receivables related to the vehicle 4. The receivables management server 2 includes a receivables management system 21, a receivables management DB 22, and a communication unit 23.

When a vehicle 4 (target vehicle) that satisfies the requirement of the engine start lock exists among the vehicles 4 managed by the receivables management DB 22, the receivables management system 21 transmits information for specifying the vehicle 4 to the receivable collection server 1. Examples of the information for specifying the vehicle 4 include a vehicle identification number (VIN number). Here, the vehicle 4 (target vehicle) that satisfies the engine start lock requirement is the vehicle 4 (target vehicle) in which a delay in payment or the like under the receivable by the debtor occurs. Further, the vehicle 4 (target vehicle) that satisfies the engine start lock requirement is the vehicle 4 (target vehicle) on which the payment of the debt is not correctly performed and the vehicle 4 on which the debt default has occurred. Further, the vehicle 4 (target vehicle) that satisfies the engine start lock requirement is the vehicle 4 or the vehicle 6 that heads toward a specified range that contains a position corresponding to the position information equal to or greater than the threshold value that is predetermined, from the range in which clustering is performed by the receivable collection server 1.

The receivables management DB 22 manages information for specifying each of the vehicles 4 and information on the receivables of the vehicle 4 in association with each other. Here, the information for specifying each of the vehicles 4 is, for example, a vehicle identification number (VIN number). The information on the receivables of the vehicle 4 is, for example, repayment information indicating a payment status, such as loan receivables and lease receivables.

The communication unit 23 is constituted of a LAN interface board, a wireless communication circuit for wireless communication, or the like. The communication unit 23 exchanges information with the receivable collection server 1 by communication via the network N.

### Function Configuration of Vehicle Information Server

Next, a function configuration of the vehicle information server 3 will be described. The vehicle information server 3 acquires the position information from the vehicle 4 and transmits the acquired position information to the receivable collection server 1 in response to a request from the receivable collection server 1. The vehicle information server 3 includes a controller 31, a vehicle information DB 32, and a communication unit 33.

The controller 31 is realized by a processor, such as a CPU, and a memory (main storage unit), such as a RAM or a ROM. The controller 31 acquires the position information from the vehicle 4 and transmits the acquired position information to the receivable collection server 1 in response to the request from the receivable collection server 1.

The vehicle information DB 32 stores the position information or the operation state information acquired from the vehicle 4 (target vehicle) or the vehicle 6 (target vehicle), and the information for specifying the vehicle 4 or the vehicle 6 (for example, a vehicle identification number (VIN number)) in association with each other. The vehicle information DB 32 transmits the position information to the receivable collection server 1 under the control of the controller 31 in response to the request from the receivable collection server 1.

The communication unit 33 is constituted of a LAN interface board, a wireless communication circuit for wireless communication, or the like. The communication unit 33 exchanges information between the receivable collection server 1, the receivables management server 2, and the vehicle 4 by communication via the network N.

### Function Configuration of Vehicle

Next, a function configuration of the vehicle 4 will be described. The vehicle 4 is a conventional vehicle (CONV), a hybrid electric vehicle (HEV), a plug-in hybrid electric vehicle (PHEV), or the like. In addition, the vehicle 4 may be a fuel cell electric vehicle (FCEV), a battery electric vehicle (BEV), or the like.

The vehicle 4 includes a memory 40, an ECU 41, an immobilizer 42, a positioning unit 43, a detection unit 44, a display device 45, a clock 46, a voice output unit 47, an input unit 48, and a communication unit 49. The detection unit 44 is, for example, a Bluetooth (registered trademark) detection device.

The memory 40 is constituted using an HDD, an SSD, or the like, and records two-dimensional (2D) map information or three-dimensional (3D) map information used by the positioning unit 43.

The ECU 41 is an electronic control unit (ECU) using a microcomputer composed of, for example, a CPU, a ROM, and a RAM as a main component. The ECU 41 activates the engine start lock of the vehicle 4 in response to a lock signal (instruction signal) for indicating the activation of the engine start lock for the remote control, in accordance with a request (remote control) from the receivable collection server 1 via the vehicle information server 3. That is, the ECU 41 controls the engine of the vehicle 4 so as not to start even when the debtor or the user presses the ignition switch to start the engine of the vehicle 4. In this case, the ECU 41 may display information indicating that the engine start is locked due to the payment delay of the debt on the display device 45 or the like included in the vehicle 4. Alternatively, the ECU 41 may display the fact that the vehicle 4 is moving to a prohibited area that is an area clustered by the receivable collection server 1 to a contact address of the creditor or the user. In the embodiment, the ECU 41 functions as a first processor.

The immobilizer 42 activates or releases the engine start lock based on the control of the ECU 41. Specifically, the immobilizer 42 activates the engine start lock or releases the engine start lock under the control of the ECU 41 according to the remote control of the vehicle information server 3. The immobilizer 42 is realized by a processor, such as a CPU, and a memory (main storage unit), such as a RAM or a ROM, and records key information (ID code) for releasing the engine start lock in the memory. The immobilizer 42 determines whether the key information included in the remote control of the vehicle information server 3 matches the key information recorded in the memory. Then, when the key information matches, the immobilizer 42 activates the engine start lock or releases the engine start lock under the control of the ECU 41 according to the remote control of the vehicle information server 3.

The positioning unit 43 receives a radio wave from, for example, a global positioning system (GPS) satellite to detect position information of the current position of the vehicle 4. The detection method of the current position of the vehicle 4 is not limited to a method using the GPS satellite. For example, a method of combining light detection and ranging or laser imaging detection and ranging (LiDAR) and two-dimensional or three-dimensional map information recorded by the memory 40 may be used.

The detection unit 44 detects a terminal device located in the vehicle 4. Specifically, the detection unit 44 is located in the vehicle 4, detects an identifier (Universally Unique Identifier (UUID)) of the terminal device that transmits Bluetooth, and detects the detection result in the ECU 41. The detection unit 44 is constituted using a Bluetooth receiver, a Bluetooth beacon, or the like.

The display device 45 is realized by, for example, a liquid crystal display (LCD) or an organic EL display (OLED). The display device 45 displays various information under the control of the ECU 41.

The clock 46 is constituted using a timer or the like having a time measurement function, measures time, and outputs a time measurement result to the ECU 41.

The voice output unit 47 is constituted using a speaker, a DA conversion circuit, an amplifier, or the like, and outputs various information under the control of the ECU 41. The voice output unit 47 converts digital voice data input from, for example, the ECU 41 into a voice and outputs the voice to the outside.

The input unit 48 is realized by, for example, a touch panel, a keyboard, or a pointing device. The input unit 48 receives an input of various operations by the user and outputs a signal according to the received operation to the ECU 41.

The communication unit 49 is constituted of, for example, a data communication module (DCM). The communication unit 49 exchanges information with the vehicle information server 3 by communication via the network N. In the embodiment, the communication unit 49 functions as a first communication unit.

### Terminal Device

Next, the terminal device 5 will be described. The terminal device 5 is an information processing terminal, such as a mobile phone. The terminal device 5 receives an input of various operations by the debtor. The terminal device 5 displays various information received from the receivable collection server 1 or the vehicle 4.

### Processing of Vehicle

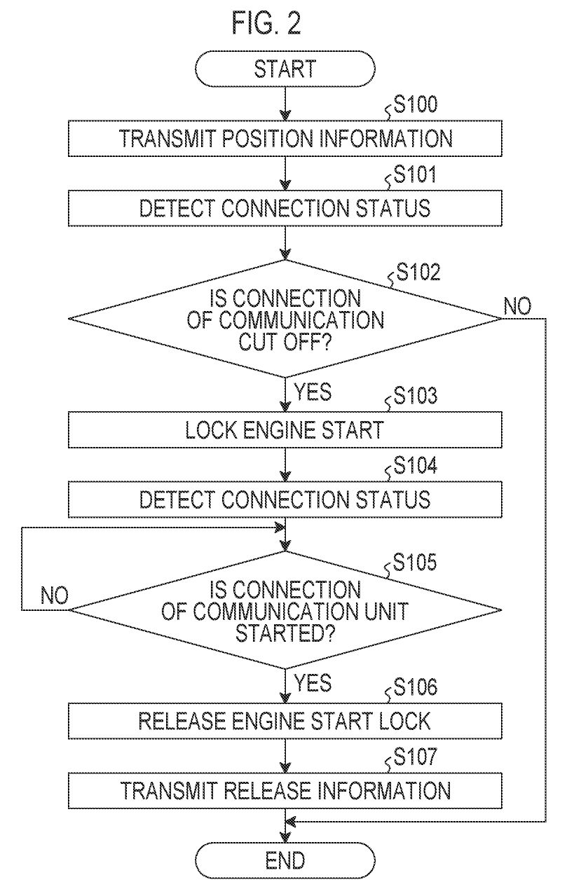

Next, an outline of processing executed by the vehicle 4 will be described. FIG. 2 is a flowchart showing an outline of the processing executed by the vehicle 4. Although the processing executed by the vehicle 4 will be described below, the vehicle 6 and other vehicles are also assumed to execute the same processing. Further, the vehicle 4 periodically executes the following processing at a predetermined interval, for example, an hourly interval.

As shown in FIG. 2, first, the positioning unit 43 transmits the position information of the vehicle 4 in response to a request for the position information from the receivable collection server 1 (S100). Further, when the ECU 41 receives the first signal indicating that the payment of the debt for the vehicle 4 or another payment by the debtor, for example, the payment of the public utility is not correctly performed from the receivable collection server 1, the ECU 41 locks the engine start of the vehicle 4.

Next, the detection unit 44 detects a connection status of the communication unit 49 (S101). Specifically, the detection unit 44 detects whether the connection status of the communication unit 49 is receiving an instruction to cut off the connection of the communication by the communication unit 49 from the outside by the controller. Alternatively, the detection unit 44 detects whether the connection of the communication by the communication unit 49 is cut off by cutting off the cable that connects the communication unit 49 and the ECU 41.

Next, the ECU 41 determines whether the connection of the communication by the communication unit 49 is cut off based on the detection result of the detection unit 44 (S102). Specifically, the ECU 41 may determine that the connection status of the communication unit 49 is receiving an instruction (cut-off instruction signal) to cut off the connection of the communication by the communication unit 49 from the outside by the controller, based on the detection result of the detection unit 44. In this case, it is determined that the connection of the communication by the communication unit 49 is cut off. On the other hand, in a case where the instruction to cut off the connection of the communication by the communication unit 49 from the outside by the controller is not received, the determination is made that the connection of the communication by the communication unit 49 is cut off. Alternatively, the ECU 41 determines whether the connection of the communication by the communication unit 49 is cut off by the cutting off of the cable that connects the communication unit 49 and the ECU 41 based on the detection result of the detection unit 44. When the ECU 41 determines that the connection of the communication by the communication unit 49 is cut off (S102: Yes), the vehicle 4 proceeds to S103. On the other hand, when the ECU 41 determines that the connection of the communication by the communication unit 49 is not cut off (S102: No), the vehicle 4 ends the processing.

Next, the ECU 41 locks the engine start of the vehicle by controlling the immobilizer 42 (S103).

Next, the detection unit 44 detects the connection status of the communication unit 49 (S104). Specifically, the detection unit 44 detects whether the connection status of the communication unit 49 is receiving an instruction to cut off the connection of the communication by the communication unit 49 from the outside by the controller. Alternatively, the detection unit 44 detects whether the connection of the communication by the communication unit 49 is cut off by cutting off the cable that connects the communication unit 49 and the ECU 41.

Next, the ECU 41 determines whether the connection of the communication by the communication unit 49 is started based on the detection result of the detection unit 44 (S105). Specifically, the ECU 41 may determine that the connection status of the communication unit 49 is not receiving an instruction (cut-off instruction signal) to cut off the connection of the communication by the communication unit 49 from the outside by the controller, based on the detection result of the detection unit 44. This is, that is, a case where the detection unit 44 cannot detect the instruction to cut off the connection of the communication by the communication unit 49 from the outside by the controller. In this case, the ECU 41 determines whether the connection of the communication by the communication unit 49 is started. When the ECU 41 determines that the connection of the communication by the communication unit 49 is started (S105: Yes), the vehicle 4 proceeds to S106. On the other hand, in a case where the ECU 41 determines that the connection of the communication by the communication unit 49 is not started (S105: No), the vehicle 4 returns to S104.

Next, the ECU 41 releases the engine start lock of the vehicle 4 by controlling the immobilizer 42 (S106), and transmits the release information of the engine start lock of the vehicle 4 to the receivable collection server 1 (S107). After S107, the vehicle 4 ends the processing.

### Processing of Receivable Collection Server

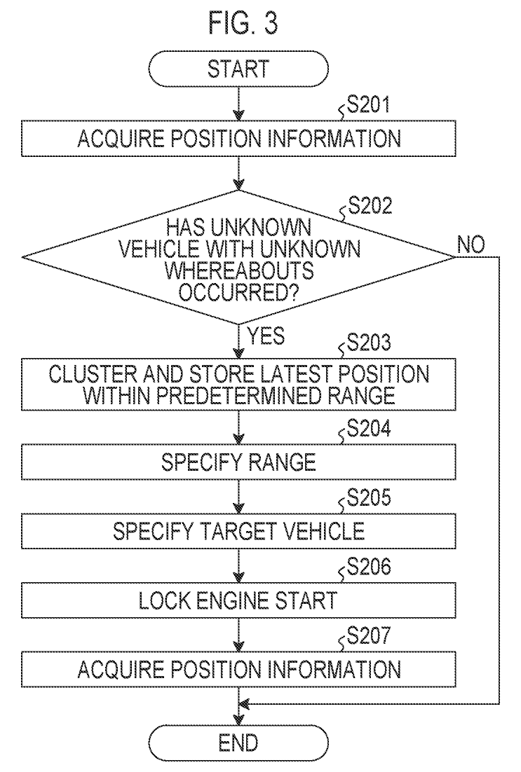

Next, processing executed by the receivable collection server 1 will be described. FIG. 3 is a diagram illustrating an outline of the processing executed by the receivable collection server 1.

As shown in FIG. 3, first, the controller 11 acquires the position information of each of the vehicles including the vehicle 4 or the vehicle 6 (S201). In this case, the controller 11 stores the position information of each of the vehicles and the vehicle identification information for identifying each of the vehicles in the position information management DB 16 in association with each other. In this case, when the controller 11 receives the first signal indicating that the payment of the debt for the vehicle 4 or another payment by the debtor, for example, the payment of the public utility is not correctly performed from the receivables management server 2, the controller 11 locks the engine start of the vehicle 4 by the remote control.

Next, the controller 11 determines whether the unknown vehicle with a communication interruption and unknown whereabouts has occurred among the vehicles including the vehicle 4 and the vehicle 6 (S202). In this case, the controller 11 requests the transmission of the position information to each of the vehicles, and determines that the vehicle for which the response to the request for transmitting the position information is not received is the unknown vehicle with the communication interruption and unknown whereabouts. When the controller 11 determines that the unknown vehicle with a communication interruption and unknown whereabouts has occurred among the vehicles including the vehicle 4 and the vehicle 6 (S202: Yes), the receivable collection server 1 proceeds to S203. On the other hand, when the controller 11 determines that the unknown vehicle with a communication interruption and unknown whereabouts has not occurred among the vehicles including the vehicle 4 and the vehicle 6 (S202: No), the receivable collection server 1 ends the processing.

Next, the controller 11 clusters and stores the latest position (position information) of the unknown vehicle stored in the position information management DB 16 within a predetermined range (S203). Specifically, the controller 11 clusters the position information of the unknown vehicle within a range of 10 km × 10 km and stores the position information of the unknown vehicle stored in the position information management DB 16. That is, the controller 11 divides a predetermined area, for example, Japan or America, into a predetermined range, plots the latest position (position information) of the unknown vehicle in the divided range, and stores the latest position information by clustering the latest position information in the position information management DB 16.

Next, the controller 11 specifies, from the range in which clustering is performed and that is stored in the position information management DB 16, a range including a position and an area equal to or greater than a threshold value that is predetermined (S204). Specifically, the controller 11 specifies, from the range in which clustering is performed and that is stored in the position information management DB 16, a range that contains a position or an area in which unknown vehicles with unknown whereabouts occur in numbers equal to or greater than the predetermined threshold value, for example, three or more unknown vehicles.

Next, the controller 11 specifies the target vehicle heading toward the range specified in S204 based on the position information of each of the vehicles (S205).

Thereafter, the controller 11 transmits the lock signal for locking the engine start of the target vehicle by the remote control to the target vehicle via the communication unit 15 (S206). In this case, the ECU 41 of the target vehicle (for example, the vehicle 6) locks the engine start by controlling the immobilizer 42 and transmits a response of the success information of the activation of the engine start lock to the receivable collection server 1. As a result, the creditor can suppress the malicious act on the target vehicle in advance.

Next, the controller 11 acquires the position information of the target vehicle via the communication unit 15 (S207). As a result, the creditor can grasp the position of the target vehicle on which the engine start is locked. After S207, the receivable collection server 1 ends the processing.

According to the embodiment described above, since the ECU 41 locks the engine start of the vehicle 4 or releases the lock on the engine start of the vehicle 4 according to the connection status of the communication unit 49, the malicious act on the vehicle 4 can be suppressed in advance.

In addition, according to the embodiment, in a case where the ECU 41 receives the instruction to cut off the connection of the communication unit 49, the engine start of the vehicle 4 is locked, and thus the malicious act on the vehicle 4 can be suppressed in advance.

In addition, according to the embodiment, in a case where the electrical connection of the communication unit 49 is cut off, the ECU 41 locks the engine start of the vehicle 4, and thus the malicious act on the vehicle 4 can be suppressed in advance.

In addition, according to the embodiment, in a case where the ECU 41 receives an instruction to start the connection of the communication unit 49, the engine start lock of the vehicle 4 is released, and thus the malicious act on the vehicle 4 can be suppressed in advance.

In addition, according to the embodiment, the controller 11 specifies the target vehicle heading toward the specified range that contains the position corresponding to the position information equal to or greater than the threshold value that is predetermined, from the range in which clustering is performed and that is stored in the position information management DB 16. Then, the lock signal for locking the engine start of the target vehicle by the remote control is transmitted to the target vehicle via the communication unit 15 to lock the engine start of the target vehicle by the remote control. Therefore, the malicious act on the vehicle 4 can be suppressed in advance.

### Other Embodiments

Further effects and modifications can be easily derived by those skilled in the art. Therefore, the broader aspects of the present disclosure are represented as above, and are not limited to the specific details and representative embodiments described above. Therefore, various changes can be made without departing from the spirit or scope of the general inventive concept defined by the appended claims and their equivalents.

For example, in the embodiment, the description is made on the premise of the receivable collection server 1 or the vehicle 4, but the function of the controller 11 or the ECU 41 may be provided in the receivables management server 2 or the vehicle information server 3 itself. In this case, the receivables management server 2 or the vehicle information server 3 may have a function of the controller 11 of the receivable collection server 1 or the vehicle history DB 12. In addition, in the vehicle control device according to the embodiment, a part of the processing of the receivable collection server 1 or the vehicle information server 3 may be performed by the vehicle 4.

In addition, in the embodiment of the present disclosure, the receivable collection server 1, the receivables management server 2, and the vehicle information server 3 have each been described as separate devices. However, the receivable collection server 1, the receivables management server 2, and the vehicle information server 3 may be constituted by one or two, or four or more devices.

What is claimed is:

1. A vehicle control device comprising:
a communication unit configured to communicate with an outside; and
a processor,
wherein the processor includes locking an engine start of a target vehicle when the processor receives, from the outside, an instruction to cut off a connection of the communication unit.

2. A vehicle control device comprising:
a communication unit configured to communicate with an outside; and
a processor,
wherein the processor is configured to lock an engine start of a target vehicle or release a lock of the engine start of the target vehicle in accordance with a connection status of the communication unit.

3. The vehicle control device according to claim 2, wherein locking the engine start of the target vehicle or releasing the lock of the engine start of the target vehicle in accordance with the connection status of the communication unit includes locking the engine start of the target vehicle when an instruction to cut off a connection of the communication unit is received.

4. The vehicle control device according to claim 2, wherein locking the engine start of the target vehicle or releasing the lock of the engine start of the target vehicle in accordance with the connection status of the communication unit includes locking the engine start of the target vehicle when an electrical connection of the communication unit is cut off.

5. The vehicle control device according to claim 2, wherein locking the engine start of the target vehicle or releasing the lock of the engine start of the target vehicle in accordance with the connection status of the communication unit includes releasing the lock of the engine start of the target vehicle when an instruction to start a connection of the communication unit is received.

6. An information processing system comprising:
multiple vehicles each including a first communication unit configured to communicate with an outside and a first processor configured to lock an engine start or release a lock of the engine start; and
an information processing device including a second communication unit configured to communicate with the vehicles and a second processor,
wherein the second processor is configured to
acquire position information of each of the vehicles at a predetermined interval,
cluster, when there is a missing vehicle with a communication interruption and unknown whereabouts among the vehicles, latest position information of the missing vehicle before the communication interruption within a predetermined range, and store the clustered latest position information in a memory,
specify a range that includes a position corresponding to the position information equal to or greater than a predetermined threshold value, from the range in which clustering is performed, and
specify a target vehicle heading toward the specified range based on the position information of each of the vehicles.

7. The information processing system according to claim 6, wherein the second processor is configured to transmit, via the second communication unit, to the target vehicle, a lock signal for locking the engine start of the target vehicle by remote control.
